(19) United States
(12) Patent Application Publication
(10) Pub. No.: US 2008/0189320 A1
(43) Pub. Date: Aug. 7, 2008

(54) Website Generator Capable of Creating Dynamic Website in Off-Line Status and Related Method

(76) Inventor: Ching-Kang Lee, Taipei City (TW)

Correspondence Address: NORTH AMERICA INTELLECTUAL PROPERTY CORPORATION, P.O. BOX 506, MERRIFIELD, VA, 22116, US

(21) Appl. No.: 12/016,200

(22) Filed: Jan. 17, 2008

Related U.S. Application Data
(60) Provisional application No. 60/888,559, filed on Feb. 7, 2007.

(51) Int. Cl. G06F 17/30

(52) U.S. Cl. 707/102; 707/E17.127

(57) ABSTRACT

To eliminate inconvenience of creating dynamic web pages on line, the present invention provides a website generator capable of creating a dynamic website at an off-line status. The website generator disconnects with a web server, which is used for publishing the dynamic website on Internet, during the off-line status. The website generator includes a database and a webpage generator. The database is used for classifying a data source according to predetermined serial numbers and categories. The webpage generator includes a plurality of templates, and is used for importing the database and generating web pages of the dynamic website according to the database and the plurality of templates.

### CROSS REFERENCE TO RELATED APPLICATIONS

This application claims the benefit of U.S. Provisional Application No. 60/888,559, filed on Feb. 7, 2007 and entitled “Website Generator Capable of Creating Dynamic Web Pages for a Website at Off-Line Status”, the contents of which are incorporated herein by reference.

### BACKGROUND OF THE INVENTION

1. Field of the Invention

The present invention relates to a website generator and related method, and more particularly to a website generator and related method for creating web pages of a website in an off-line status.

2. Description of the Prior Art

With web technologies advanced, many websites not only can include text contents but also can display video, animations or provide functions to interact with users, or called browsers. The most common interaction between a website and the users is that the users can upload text or image contents to a web server, which stores the website, and the web server displays the text or image contents via certain functions built for web pages of the website. Such web pages, which can make interaction between the websites and the users, are called dynamic web pages whereas the web pages, which only display data or images to the users, are called static web pages. In order to achieve functions of the interactions, the dynamic web pages commonly requires many web technologies for both the user side and the web-server side. At the user side, the users' facilities to access the website require applications, such as Java Script, Java applets, Flash. At the web server side, the web server requires technologies of Dynamic HTML (DHTML), Hypertext Preprocessor (PHP), Active Server Page (ASP), Perl and etc. Thus, creating a dynamic website with a large amount of data often consumes time and resource.

Take a shopping website (dynamic website) as an instance, buyers can stay any places, where provides facilities for surfing Internet, to search the products they want on websites. On the other hand, the web servers, such as Yahoo shopping, Amazon or eBay, provide space for sellers to establish on-line shopping websites. In general, the web servers utilize the technologies of dynamic web pages and thereby allow the sellers uploading information of the store and merchandise on their own webs. For a seller, a conventional method to create a shopping store website includes: (a) register (log-in) to a web server; (b) upload the merchandise information, such as a title, a category, price and an item image; (c) connect to a specific website belonging to each piece of uploaded merchandise to check out if the related information is appropriately and accurately displayed on the website.

Please refer to FIG. 1, which is a schematic diagram of a web page 10 for uploading product information according to an embodiment of the prior art. The web page 10 includes blanks 100-110 and a button 112, labeled with ‘Submit’. The blanks 100-110 correspond to Title, Image, Price, Expiration Date, Category and Description, respectively. When the seller adds a new item to his/her shopping website, the seller has to connect to the web server via Internet at first. The web server responds to the seller with the web page 10 for uploading the merchandise information. The seller fills in the blanks 100-110 and clicks the button 112 to send the information to the web server. The web server then creates a response page specific to the item after receiving the information via Internet. On the other hand, the seller can check out the uploaded result on the response page after the web server notifies the seller of a web address specific to the response page.

The whole process quite wastes time and resource for the seller. For example, if the seller has a large amount of merchandise to sell on the shopping website, the seller needs to access the web page 10 repeatedly for each piece of merchandise since the web page 10 can carry information for only one product. Thus, this wastes lots of time and the seller needs to remember which products have been uploaded and which products have not.

To remove the abovementioned inconvenience, some web servers provide an uploading page capable of carrying information of multiple pieces of merchandise. However, the seller has to always keep on-line to key in the information or add images into the uploading page before the uploading page is accomplished. However, as well known in the art, Internet connections are unstable and uncontrollable. Therefore, if the connection between the seller and the web server breaks off during the uploading of the uploading page, the seller will lose all of the information carried by the uploading page. The whole process to upload information needs to be redone, which wastes the seller much more time and resource.

According to the prior art, any users who would like to establishing a dynamic website on a web server have to upload data for many times via Internet. Besides, uploading the information related to the dynamic website through the unstable connection is a risk for the users.

### SUMMARY OF THE INVENTION

Therefore, the present invention provides a website generator for creating web pages for a website, allowing users establishing and altering the website in an off-line status.

The present invention discloses a website generator capable of creating a dynamic website at an off-line status. The website generator includes a database and a webpage generator. The database is used for classifying a data source according to predetermined serial numbers and predetermined categories. The webpage generator includes a plurality of templates, and is used for importing the database and generating web pages of the dynamic website according to the database and the plurality of templates. The website generator disconnects with a web server, which is used for publishing the dynamic website on Internet, during the off-line status.

The present invention discloses a method of creating a dynamic website. The method includes: operating in an off-line status to keep disconnecting with a web server which is used for publishing the dynamic website on Internet, classifying a data source according to predetermined serial numbers and categories, and importing the database and generating web pages of the dynamic website according to the classified data source and a plurality of templates.

These and other objectives of the present invention will no doubt become obvious to those of ordinary skill in the art after reading the following detailed description of the preferred embodiment that is illustrated in the various figures and drawings.

### BRIEF DESCRIPTION OF THE DRAWINGS

FIG. 1 is a schematic diagram of a web page for uploading product information according to an embodiment of the prior art.

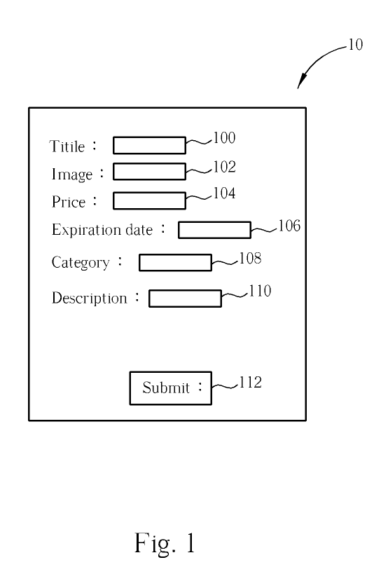

FIG. 2 is a schematic diagram of a website generator capable of creating web pages for a website at off-line status according to an embodiment of the present invention.

FIG. 3 is a schematic diagram of a first page of the website of the FIG. 2.

FIG. 4 is a schematic diagram of a table of the database according to an embodiment of the present invention.

FIG. 5 is a schematic diagram of a table of the database according to an embodiment of the present invention.

FIG. 6 is a schematic diagram of a category list of a block of a website according to an embodiment of the present invention.

FIG. 7 is a schematic diagram of a data table of a database corresponding to the category list according to FIG. 6.

FIG. 8 is a flowchart of a process for generating a dynamic website according to an embodiment of the present invention.

### DETAILED DESCRIPTION

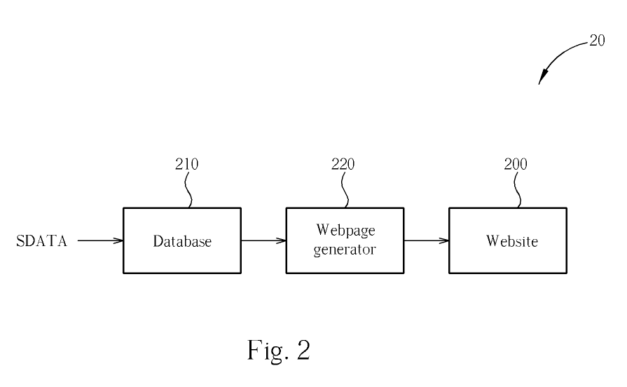

Please refer to FIG. 2 which is a schematic diagram of a website generator 20 according to the present invention. The website generator 20 is capable of creating a dynamic website 200 in an off-line status and includes a database 210 and a webpage generator 220. During the off-line status, the website generator 20 needlessly connects to Internet and keeps disconnection with a web server which publishes the website 200 on Internet with a specific address. The database 210 and a webpage generator 220 can be integrated in a personal computer (PC) or an electronic device with compatible operating system. The database 210 is used for classifying and storing a data source SDATA including various data contents, such as text, image, video and Flash clips. The database can be built in Excel, Comma Separated Value (CSV), XML or Access data formats and thereby the data source SDATA is classified with built-in categories in a table or a hierarchical (tree-like) manner.

Taking a database adopting the Excel file format as example, the predetermined serial numbers and categories can form a table where the data source SDATA is inputted in corresponding fields. The webpage generator 220 is used for importing the database 210 for capturing the classified data source. Besides, the webpage generator 220 includes a plurality of templates including many applications or settings, such as DHTML, PHP, ASP, Java Script, Jscript, to enable the dynamic functions of the dynamic website 200. As a result, the webpage generator 220 chooses necessary templates and does corresponding settings for the imported data of the database 210 to create web pages of the website 200. The settings of the templates include image-size adjustment, searching function, and selection of dynamic webpage appearance design, such as color gradient, marquee and water wave. In this way, the corresponding text, image or video contents are displayed at corresponding locations and in a variety of models on the web pages. In the embodiment of the present invention, the webpage generator 220 and the database 210 can be integrated in a personal computer (PC) so that users unnecessarily connect to a web server or Internet during the whole process of generating the website 200. When the website 200 is uploaded to the web server, the user does not lose the inputted data if the uploading is failed. The only thing the user has to redo is re-uploading the website 200. Therefore, the users will not suffer the problem of losing all inputted data due to a sudden connecting error or a response failure.

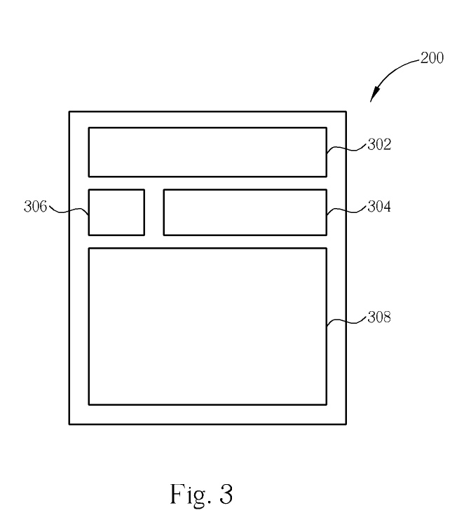

Please refer to FIG. 3 which is a schematic diagram of the front page 300 of the website 200 according to an embodiment of the present invention. The front page 300 includes blocks 302-308. The block 302 is used for displaying a store or company name with decoration of text and images; the block 304 includes some advertisements, displayed with image or animation clip, such as a video clip or a Flash clip; the block 306 can provide users a searching function for searching any information inside the website 200; the block 308 is used for displaying plenty of merchandise and each piece of merchandise can be characterized with a image, a title, price and description. Besides, the website 200 sets hyperlinks for the blocks 302-308 so that a web browser can explore details of the advertisements or the merchandise by linking to other web pages of the website 200.

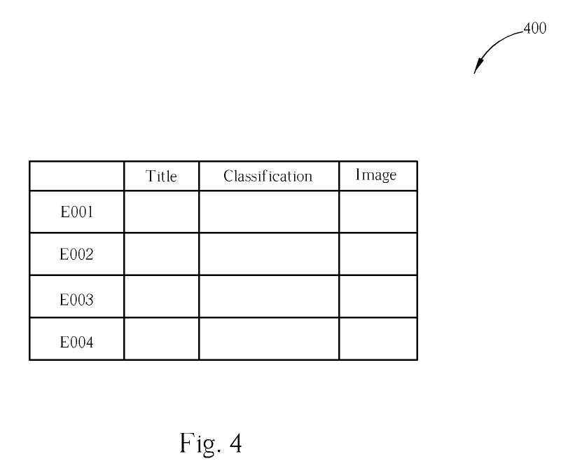

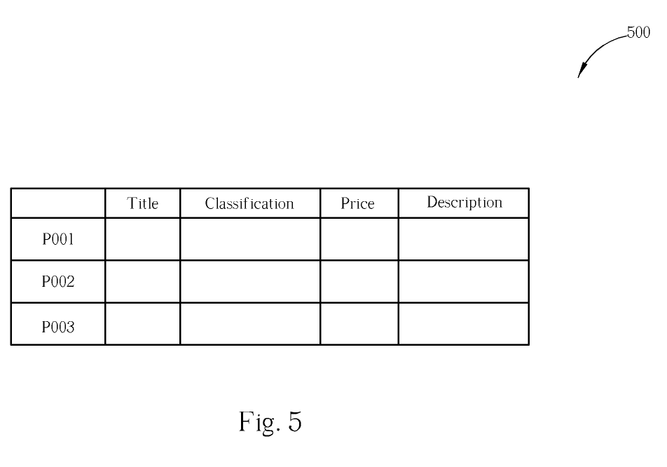

According to the front page 300, the database 210 should store related information of the blocks in the predetermined categories. Please refer to FIG. 4, which is a schematic diagram of a table 400 of the database 210 according to an embodiment of the present invention. The table 400 is built to store information corresponding to the first page 300. The table 400 includes serial numbers E001-E004, corresponding to the blocks 302-308, respectively. Each of the serial numbers E001-E004 represents an item and is allocated fields of Title, Classification, and Image. The data source SDATA is thereby classified and filled into the corresponding fields. Please refer to FIG. 5, which is a schematic diagram of a table 500 of the database 210 according to an embodiment of the present invention. The table 500 is similar to FIG. 4 and used the related information of the merchandise in the block 308. The table 500 could be at a lower layer of the layer of table 400.

During the off-line status, the webpage generator 220 directly imports the database 210 without any connections to Internet. The webpage generator 220 includes the templates for various of purposes, such as industrial classifications, page styles and page allocation adjustments, and each template includes some applications, such as Java applets, VBScript and Jscript, for providing special functions to perform searching, marquee or animation effects on the website 200. The webpage generator 220 selects required templates for each web page. For example, for the front page 300, a template with four blocks will be selected. In addition, the webpage generator 220 applies data of the database 210 to the selected templates to create the web pages of the website 200. In the embodiment of the present invention, when the website 200 of FIG. 3 is expected to be created, the data is firstly stored into the database 210 field by field from the serial numbers (items) E001-E004 or P001-P004. The webpage generator 220 then imports the tables 400 and 500 and puts effects of the selected templates on the field data of tables 400 and 500.

As can be seen from the above, when a user has plenty of merchandise to display on a website, the user can do the whole process without connection with the web server via Internet. In addition, when the user needs to alter or copy the website, the user can directly modify the data stored in the database or change the template settings of the webpage generator 220.

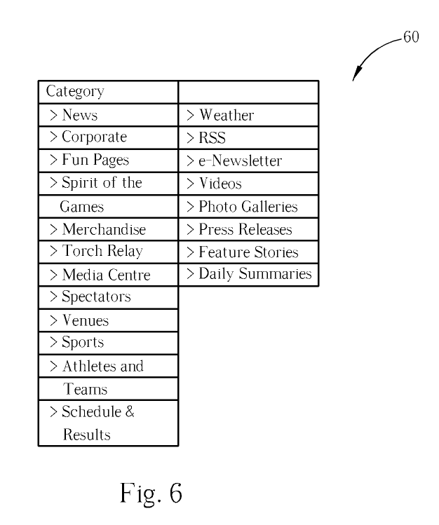

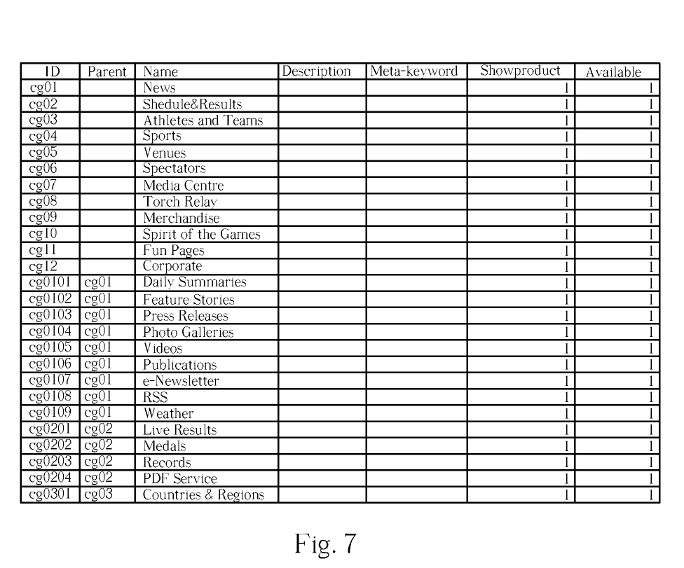

Please refer to FIG. 6 and FIG. 7. FIG. 6 is a schematic diagram of a category list 60 of a block of a website according to an embodiment of the present invention, while FIG. 7 is a schematic diagram of a data table 70 of a database corresponding to the category list of FIG. 6. If the website, such as website 200 in FIG. 2, is expected to install a block including the category list 60, we need to establish the data table 70 in the database. The category list 60 includes a main list and a plurality of sub-lists. The main list includes a plurality of titles “News”, “Schedule & Results”, “Athletes and Teams”, “Sports”, “Venues”, “Spectators”, “Media Centre”, “Torch Relay”, “Merchandise”, “Spirit of the Games”, “Fun Pages” and “Corporate”. Besides, the “News” of the main list includes a sub-list where there are a plurality of titles “Daily Summaries”, “Feature Stories”, “Press Releases”, “Photo Galleries”, “Videos”, “Publications”, “e-Newsletter”, “RSS”, “Weather”, “Live Results”, “Medals”, “Records”, “PDF Service” and “Countries & Regions”. Thus, the titles of the main list and the sub-list are the text data, which needs to be input to the data table 70. In FIG. 7, the data table 70 includes a plurality of column data titled with “id”, “parent”, “name”, “description”, “meta-keyword”, “meta-description”, “showproduct” and “available”. The column data “name” is inputted with the titles of the main list and the sub-list according to the category list 60 whereas the column data “id” is built-in serial numbers corresponding the each field of the column data “name”. The column data “parent” is used for record the parent list of the corresponding field in the column data “name”. Therefore, if the data table 70 is import into a webpage generator after the titles of the main list and the sub-list are inputted into the data table 70, a website, including a list block as the category list 60, will be generated.

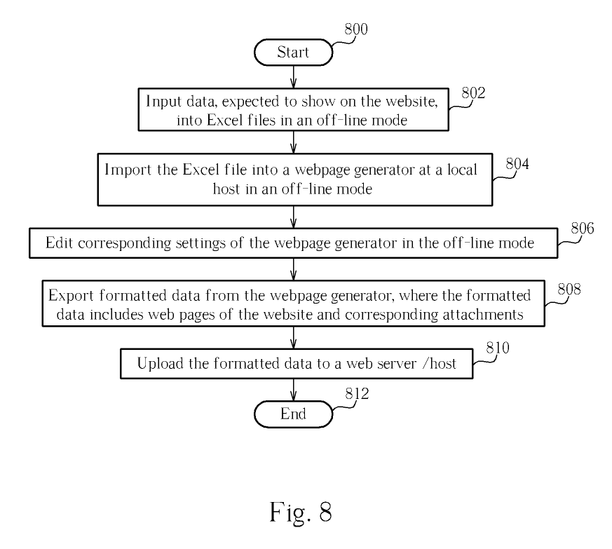

Please refer to FIG. 8, which is a flowchart of a process 80 for generating a dynamic website according to an embodiment of the present invention. The process 80 includes the following steps:

Step 800: Start.

Step 802: Input data, expected to show on the website, into Excel files (a database) in an off-line mode.

Step 804: Import the Excel file into a webpage generator at a local host (PC) in the off-line mode.

Step 806: Edit corresponding settings of the webpage generator in the off-line mode.

Step 808: Export formatted data from the webpage generator, where the formatted data includes web pages of the website and corresponding attachments.

Step 810: Upload the formatted data to a web server/host.

Step 812: End.

According to the process 80, when inputting the data into Excel files in the Step 802, there are several steps to be followed: (a) select a template; (b) use Excel to input the text data; (c) import non-text data, such as image, audio, video, flash and etc., into the Excel files according to corresponding serial numbers, such as serial numbers in the data table 70 of FIG. 7. In Step 804, there are several steps to be followed: (a) select the templates to establish a prototype of the website, where the template can be provided by the webpage generator at the local host or can be download from the web server/host; (b) transform the Excel files into XML data format; (c) import the XML files and the non-text data into the webpage generator/local host; (d) export files, combined with the template and the imported data, after editing related settings for generating the web pages of the website.

In the Step 806, the corresponding settings are various functions adopted in the static and dynamic webpage, such as patterns of background, subtitles of a Flash movie clip . . . etc. Besides the Step 802 and 804, the Step 806 operates in the off-line mode. That is to say, the users do not have to connect to any networks during the Step 802, 804 and 806. In the Step 808, the formatted data is in a specific data format and includes web pages of the website and corresponding attachments. The corresponding attachments may be original images of the image data inputted into the Excel files. At last, in the Step 810, the web pages of the website are uploaded to the web server/host via Internet or other networks. As known form the process 80, the whole process to generate the web pages of the web site can be accomplished in the local host. Therefore, if there are errors occurred during uploading the web-page files of the web site to the web server via Internet, although the users lose the uploaded web-page files, users still keep the web-page files in the local host so that the users just have to re-upload the web-page files instead of redoing the whole process again. Thus, the users can save time and resource.

In summary, according to the prior art, when a user want to create a website, the user needs to log in a web server, input the data and image into a web page, and upload the web page to the web server. Accordingly, the web server creates a specific web page based on the uploaded data. The user can check the uploaded results only via the specific web page. In this circumstance, the amount of uploading data for each web page is restricted. If there is a large amount data to upload, the user has to access the web server for many times. In addition, the whole process operates in an on-line status, which means that the user has to keep connection with the web server via Internet. If the connection breaks off during the uploading, the user will lose all of the inputted data. If the users want to alter the data displayed on the website, the users have to log in again and do modifications on-line. Therefore, the prior art wastes time and resource for the user. Compared with the prior art, the present invention allow the user create a website at an off-line status (needlessly to connect to the web server). The user can input a large amount of data into the database at a time, and directly see the website via the webpage generator. When the user wants to alter the website, the database and the webpage can be directly modified off-line. Therefore, the present invention provides a website generator capable of creating web pages for a website off-line.

Those skilled in the art will readily observe that numerous modifications and alterations of the device and method may be made while retaining the teachings of the invention. Accordingly, the above disclosure should be construed as limited only by the metes and bounds of the appended claims.

What is claimed is:

1. A website generator capable of creating a dynamic website in an off-line status, the website generator comprising:
a database for classifying a data source according to predetermined serial numbers and predetermined categories; and
a webpage generator comprising a plurality of templates, for importing the database and generating web pages of the dynamic website according to the database and the plurality of templates;
wherein the website generator disconnects with a web server, which is used for publishing the dynamic website on Internet, during the off-line status.

2. The website generator of claim 1, wherein the data source comprises text, image, video or Flash clip contents.

3. The website generator of claim 1, wherein the database stores the data source in Excel, Comma Separated Value (CSV), Extensible Markup Language (XML) or Access data file formats.

4. The website generator of claim 1, wherein the database comprises a plurality of tables corresponding to the serial numbers and categories.

5. The website generator of claim 1, wherein the predetermined serial numbers and the predetermined categories are arranged in a hierarchical manner.

6. The website generator of claim 1, wherein the plurality of templates comprises dynamic HTML (DHTML), hypertext preprocessor (PHP), Active Server Pages (ASP), Java Script and JavaScript functions.

7. A method of creating a dynamic website, the method comprising:
operating in an off-line status to keep disconnecting with a web server which is used for publishing the dynamic website on Internet;
classifying a data source according to predetermined serial numbers and categories; and
importing the database and generating web pages of the dynamic website according to the classified data source and a plurality of templates.

8. The method of claim 7, wherein the data source comprises text, image, video or Flash clip contents.

9. The method of claim 7 further comprising storing the data source in Excel, Comma Separated Value (CSV), Extensible Markup Language (XML) or Access data file formats.

10. The method of claim 7, wherein the serial numbers and categories are pre-built in a plurality of tables.

11. The method of claim 7, wherein the predetermined serial numbers and the predetermined categories are arranged in a hierarchical manner.

12. The method of claim 7, wherein the plurality of templates comprises dynamic HTML (DHTML), hypertext preprocessor (PHP), Active Server Pages (ASP), Java Script and JavaScript functions.
